(19) United States
(12) Patent Application Publication
(10) Pub. No.: US 2017/0171118 A1
(43) Pub. Date: Jun. 15, 2017

(54) SOCIAL MEDIA RATING SYSTEM

(71) Applicant: Razmig ARZOUMANIAN, Hackensack, NJ (US)

(72) Inventor: Razmig ARZOUMANIAN, Hackensack, NJ (US)

(21) Appl. No.: 15/068,797

(22) Filed: Mar. 14, 2016

Related U.S. Application Data
(63) Continuation-in-part of application No. 14/963,471, filed on Dec. 9, 2015.

(51) Int. Cl. H04L 12/58; H04L 29/08

(52) U.S. Cl. CPC H04L 51/04; H04L 51/32; H04L 51/08; H04L 51/12; H04L 67/06

(57) ABSTRACT

System for anonymous user chat between a first anonymous user at a first network node and a second known user at a second node of an electronic network, comprises a list of users at the first node, the list including the second user; a chat control to allow the first user to select the second user from the list and initiate chat with the second user, the chat initiation being anonymous and thereby not identifying the first node or the first user.

### RELATED APPLICATION/S

This application is a Continuation-in-Part (CIP) of U.S. patent application Ser. No. 14/963,471 filed on Dec. 9, 2015, the contents of which are incorporated herein by reference in their entirety.

### FIELD AND BACKGROUND OF THE INVENTION

The present invention, in some embodiments thereof, relates to a social media rating system and, more particularly, but not exclusively, to a social media rating system that provides users with anonymous feedback from those other users in the network with whom they interact.

It is known to rate in terms of attributes in psychology tests and in the corporate environment. In psychology it tends to be either self-assessment or assessment by a health care professional. In the corporate environment there is usually assessment by a manager or again, self assessment.

People who are active on social networks often want to get honest feedback from people they know. They can explicitly ask, but then the concern is that the results may lack honesty, and there is no mechanism for unsolicited feedback, at least not of a sophisticated nature. Only an anonymous repository can encourage multiple people to give honest and sophisticated feedback.

Such feedback may help an advertiser understand the inner workings of a social network. It is noted that external connections on a social network can be very misleading. For example when an advertiser wants to discover the most influential people in a network, it is possible to discover the numbers of people looking at profiles, etc, but there is no guarantee that the most viewed profiles are the most influential. Often profiles with good photographs are looked at most often, with no connection to their being at all influential in the network in question.

### SUMMARY OF THE INVENTION

The present embodiments may provide a route for in-depth anonymous chat and assessment across an electronic network. The assessments may be solicited or unsolicited.

According to an aspect of some embodiments of the present invention there is provided a system for anonymous user chat between a first anonymous user at a first network node and a second known user at a second node of an electronic network, the system comprising:

a first network node having a first user;

a second network node having a second user;

a list of users at said first node, said list including said second user;

a chat control to allow said first user to select said second user from said list and initiate chat with said second user, said chat initiation being anonymous and thereby not identifying said first node or said first user.

The system may comprise a file exchange for allowing files to be exchanged between said nodes.

The system may comprise a semantic engine to monitor chat on said network.

In an embodiment, said semantic engine is configured to recognize terms in use between particular sets of chat users.

In an embodiment, said semantic engine is configured to learn terms in use between particular sets of chat users.

In an embodiment, said semantic engine is configured to monitor said chat users for signs of misuse.

In an embodiment, said semantic engine is connected to a blocking unit to block chat users found to have carried out misuse.

In an embodiment, said semantic engine is located on a user device.

In an embodiment, said semantic engine is located on a server.

An embodiment may comprise a blocking unit to allow individual chat users to block any other chat user from communicating with them.

An embodiment may comprise an anonymity lifting setting to allow a chat user to waive anonymity.

An embodiment may allow one user to provide one or more other users to comment anonymously on.

According to a second aspect of the present invention there is provided a method for anonymous user chat between a first anonymous user at a first network node and a second known user at a second node of an electronic network, the method comprising:

allowing a first user to select a second user and initiate chat with said second user, said chat initiation being anonymous and thereby not identifying said first node or said first user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing an apparatus according to a first embodiment of the present invention;

FIG. 2 is a simplified diagram showing a method for using the apparatus of FIG. 1;

FIG. 3 is a simplified schematic user screen showing rating according to attributes and sub-attributes according to an embodiment of the present invention;

FIGS. 4A to 4C are simplified diagrams showing scores both as positions on sliders and as expressions on emoticons, according to embodiments of the present invention; and

FIG. 5 is a simplified diagram showing the chat system of FIG. 1.

### DESCRIPTION OF SPECIFIC EMBODIMENTS OF THE INVENTION

The present invention, in some embodiments thereof, relates to a social media rating system and, more particularly, but not exclusively, to a system that allows for electronic feedback on an electronic network.

In one embodiment, a feedback form may be formulated by the user requiring feedback, typically using templates provided by the system or adapted from templates provided by the system. Feedback questions and answers may be set by the user or integrated from the template, with or without modification, and the questions may be tiered. Any given respondent may be given just the highest tier of questions to answer, or all the tiers. The system may allow for users filling in a basic response form with just a single tier to subsequently be provided with a deeper tier of questions.

The system is designed to be anonymous, so feedback forms may be required to be sent out to at least a threshold number of potential responders. It is noted that the responders correspond to nodes on an electronic network wherein the nodes may have an organizational location or a geographic location or the like, and the locations may be taken into account in considering who to ask and or how to weight or otherwise assess the answers.

In an alternative embodiment, a basic feedback form always exists, and connections are always able to rate another user using the basic form. The user being rated may then be notified that the feedback is present and may download an application in order to see the ratings. The user being rated may ignore the ratings, say by not downloading the application but cannot stop any of his or her connections from providing ratings.

Once the user has downloaded the application, the user is not only enabled to see the ratings but is also able to modify the attributes and add sub-attributes as desired in order to direct the feedback being obtained. Modified attributes may be made available to all contacts or just to a chosen sub-set of contacts as desired.

The system may be integrated into existing social media or organizational networks, and may use friends lists or contact lists to suggest who to ask for assessment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

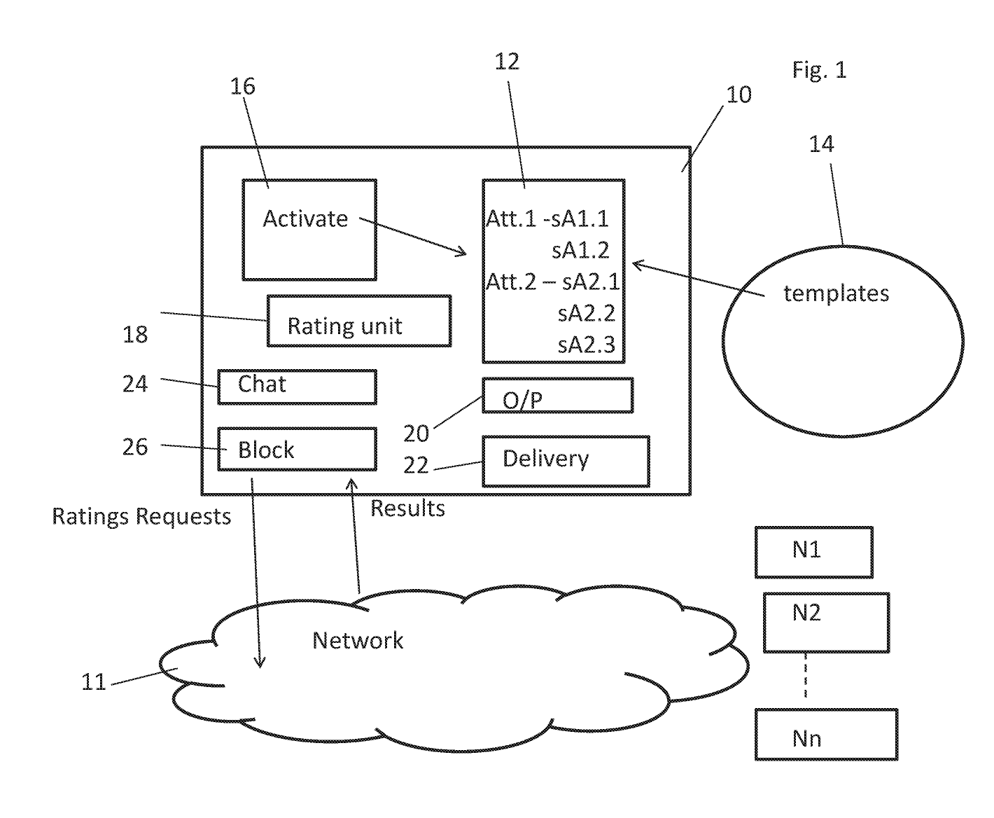

Referring now to the drawings, FIG. 1 illustrates apparatus 10 for anonymous user feedback from nodes of an electronic network. The apparatus is connected to a network 11 such as an organizational network or the internet or a social network. The network has nodes N1, N2 . . . Nn which represent users. The apparatus comprises an attribute register 12 in which attributes Att1, Att2 etc are set up for feedback, some of which attributes have sub-attributes sA. The attributes and their arrangement into main and sub-attributes may be defined by a template from a template store 14, or may be user defined, or the user may modify the template. An activation unit 16 allows a first user at a first node, who has a link to the activation unit 16, to request anonymous ratings from other nodes of the network 11.

Node inputs at other network nodes allow users asked for feedback to vote by applying scores to the attributes or sub-attributes. The results return from the network and reach rating unit 18 for calculating overall attribute scores. Typically the overall scores are aggregated from the individual scores for each attribute or sub-attribute. An output unit 20 may format and supply the overall attribute scores to the first user. The output unit may ensure that the results are supplied in such a way as to prevent particular scores from being identified with particular users so that the rating remains anonymous.

In one embodiment, no-one is asked for feedback. The basic feedback form is available to all connections of a particular user and can be used to provide ratings. The particular user may modify the form to provide more detailed or more directed feedback which modifications may then override the basic form.

The rating unit 18 may allow a given node to change its vote. That is to say the sources of the particular votes are known to the rating unit, say from a login or from a phone number. Thus the rating unit may deduct the original vote from that source and then add back the new vote, ensuring that the particular user does not have an opportunity to skew the results unfairly. Alternatively, the particular user may be able to withdraw their vote without providing a new score in its place. For example an organization may be able in this way to discount the views of people who have recently left the organization.

The activation unit allows the user requesting a rating to group nodes into clusters and to weight results according to the clusters. Thus, for example within a company, nodes may be grouped according to their position within the organization, and then an individual manager can apply different weightings to assessments from those working for him/her and those working alongside him/her. Alternatively different questions may be provided to different clusters, and separate results may be provided for the different clusters, instead of or in addition to overall results.

A delivery unit 22 is similar to the output unit but provides assessment results to other users than the user requesting or who is the subject of the assessment. The delivery unit may have rules or policies defining the circumstances in which it can provide results to specific nodes. Thus the requesting user may define particular users or classes of users who may be provided results, or may approve individuals, or results may be provided automatically to managers or to customers.

Network 11 may be a social network, with groups of contacts in different categories such as family, close friends, more distant friends, work colleagues, and the nodes may be clustered according to social interaction. Clustering information may be obtained using the friends list or contacts list of a given user. Alternatively, network 11 may be an organizational network and the nodes may be clustered according to an organizational hierarchy, who works for whom, what department etc.

As a further alternative, network 11 may be a geographically distributed network, and the nodes can be clustered according to location. A business may for example be interested in obtaining feedback from its customers, and may use addresses and postcodes or other location information to categorize the customers as socio-economic groups. Location information may be provided automatically by mobile telephones, and in other cases address book information may be used, say to obtain postcodes.

As shown in FIG. 1, the apparatus is made available to a network, say via a server, and individual users interact via links on their terminal devices, the devices being any device that can operate a link or run a browser, such as a computer, including a desktop computer, laptop computer, tablet, pad, pod, and mobile telephone. Alternatively a user client can be provided to the terminal device, including an application usable on a mobile telephony device or pod or pad or tablet etc.

As discussed, the questionnaire that is sent for feedback may be put together by obtaining attributes and sub-attributes from a template, and building up the questionnaire. Some attributes may be provided with a numerical answer—say a rating of 1 to 10 for fairness. Other attributes may demand a verbal answer, particularly at the sub-attribute levels, which are intended to be more nuanced. The user setting up the questionnaire may be constrained by the template to get numerical answers, or may be encouraged to ask for verbal answers. It is noted that verbal answers are harder to process, and thus it is useful to keep verbal answers for handpicked focus groups rather than for use with large numbers of respondents.

Verbal type attributes may in fact include requests for advice. As an example the user may, in a first round sent to large numbers of respondents, have got a poor rating for his telephone manner. In response a more detailed follow up questionnaire, directed at those giving a poor rating may ask, “how can I improve my telephone manner?”

The user may then address the questionnaire individually, but it is far easier if access is made to a contact list, such as Facebook™ friends, the Outlook™ contacts list etc, and then the apparatus suggests targets, which the user may then approve. A phone contact list, an email contact list, a social media contact list, a company contact list, an organizational contact list, or a list of Twitter™ followers are other examples of lists that may be used.

Distribution of the questions may be carried out in several ways. As above, the user may design a questionnaire and then designate individuals or groups to whom the questionnaire may be sent. The questionnaire may then be sent unsolicited to the recipient, who may answer or may choose to ignore it.

As a further possibility, no message is sent at all, however the designated people may see the menus etc for rating when clicking on contact information etc of the person requesting the rating.

In another embodiment, particularly aimed at the corporate environment, rating may be outrightly requested or even demanded. Companies may require their staff to answer particular questionnaires, and thus a new method is provided of anonymous interaction among members of an organization. Using such a method, profiles may be built up using rating information, and this may be combined with other information from social networks and online activity in general to create a profile that is culled from multiple sources and thus is more objective than is possible to obtain today. In one embodiment, such a profile may be used to identify developing extremism in an objective way.

Once the apparatus obtains access to contact lists, it is possible to compare contact lists of respective nodes, that is of different devices, and it is possible to infer that different nodes with the same contact lists are in fact different devices of a single user. The inference may be made from the contact identities, but may be even stronger if the same contact identity is given the same nickname, as nicknames may be individual to the user who owns the contact list.

As well as sending different questions or weighting results from different clusters, the user may be able to indicate particular individuals for a focus group for sending different ratings questions. Again the group, although it may be small, may be constrained to be at least a certain size to guarantee anonymity.

A company or like organization can send employees lists of other people so that they can comment anonymously on the people in the list.

In an embodiment, a semantic engine is used to spot bullying, harassment and misuse. The semantic engine contains a learning capacity as certain terms may be abusive in one context and not in another. The semantic engine may be located on the end-user device or on a server or at any other suitable location and is configured to have a semantic understanding of the kind of chat messages used on the system.

The apparatus may also include an anonymous messaging or chat facility 24 to allow a user to ask specific questions anonymously following the rating. The user does not know who he/she is chatting with but the apparatus itself has the necessary contact information to operate the chat feature. The chat facility may show if a particular user is online and available for chat or not. The chat facility may allow sending of files. In this way one can distribute a file and then obtain anonymous opinions on the contents of the file.

Blocking feature 26 may allow specific users to be identified to the system and to be blocked, while remaining anonymous to the first user. Blocking may be specific, meaning that the blocked individual is blocked from interacting with a specific node where problems were caused, or blocking may be general, in which an individual causing problems is blocked from the system as a whole. Blocking from interacting with a specific node may happen say after an unpleasant chat interaction. Blocking due to bullying or other misuse may be initiated by users or by the semantic engine referred to above. In addition, the system as a whole may note the ratings an individual gives to other users and these generally follow a distribution such as a Gaussian distribution. If a user however consistently gives the lowest scores across the board without any signs of a distribution, then they may be assumed to be someone with an axe to grind and may be blocked in general.

Whether the blocking is general or specific, it may be anonymous.

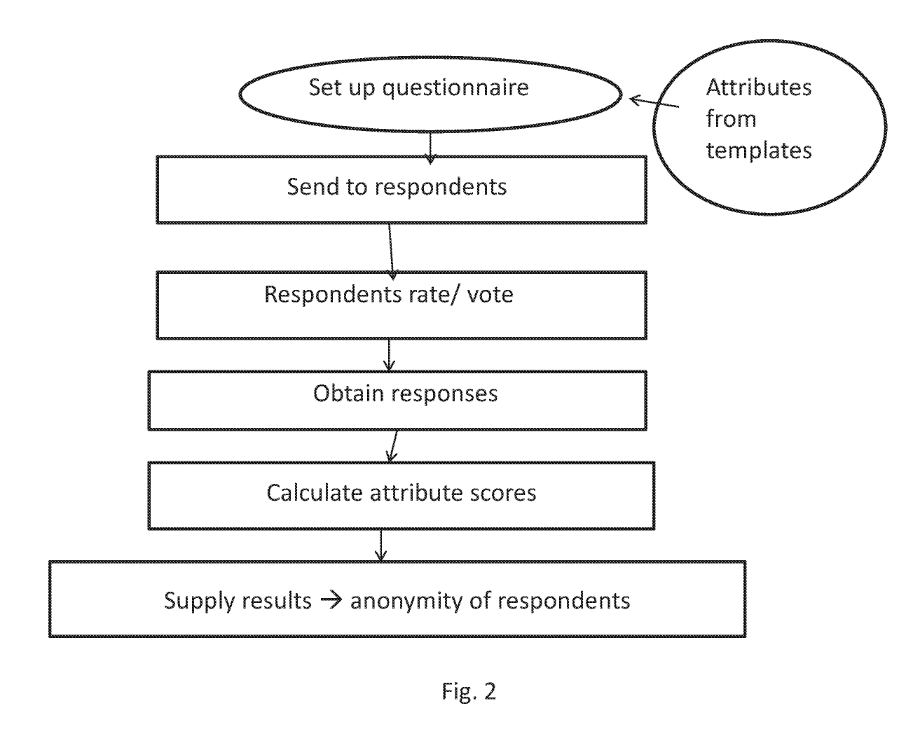

Reference is now made to FIG. 2, which illustrates a method of using the apparatus of FIG. 1. A user puts together a series of attributes that he/she wants feedback on, into a questionnaire—30. The attributes and sub-attributes are typically taken from templates 32. The questionnaire is then sent with a request for anonymous ratings to other nodes on the network—34. The recipients are able to rate or vote by applying scores to the attributes or sub-attributes—36. The scores may be numerical or verbal. The results are retrieved by the system—38 and then overall attribute scores are calculated for each attribute based on the individual sub-attribute scores applied to respective sub attributes by individual raters—40, and then the results are supplied to the requesting user in a such a way as to maintain the anonymity of the raters. In the case of verbal responses which cannot be summed, the responses themselves are presented to the user.

The apparatus may be provided as an add-on to social networking applications such as Facebook™, LinkedIn™, dating apps in general, company internal networks etc. Alternatively the apparatus may be independent of other applications.

The assessment may thus be initiated by the user requiring assessment, and the assessment itself may be made anonymously by social media contacts. Thus the user is able to obtain honest feedback from people he/she knows or is in contact with. The individual users are able to waive their anonymity if they so desire. Anonymity may be waived for the chat network as a whole or for a particular chat user or for a specified group of chat users.

The clustering feature may allow users to sort feedback according to various groups on their network, such as family, co-workers, friends, business colleagues, customers. Providing feedback may be as simple as clicking on the requesting user on one's contact list, obtaining a set of attributes and providing each attribute with a number. Alternatively a given attribute when clicked on may reveal a set of sub-attributes.

Within companies, the company hierarchy can be used to make sense of ratings. Thus it may become apparent that a particular person gets on well with those under him but not so well with his equals or vice versa. With smaller organizations there may be an issue with guaranteeing anonymity of the raters but in any event it is larger organizations that may benefit most from obtaining feedback information in this way.

Although the users are anonymous to each other, they need not be anonymous to the system. The system may know from phone numbers or from a social network identity just who each user is, or it may supply users with their own access code or use cookies.

As discussed above, there may be an option to make the information available to say potential customers or potential employers, via the delivery unit 22 mentioned above, and there may be an option to erase the information. Other users who may be interested in the feedback may include potential dates on a dating app.

Interactions with social media today are increasingly via mobile telephone and thus the apparatus may be designed to interact with home screens and the like.

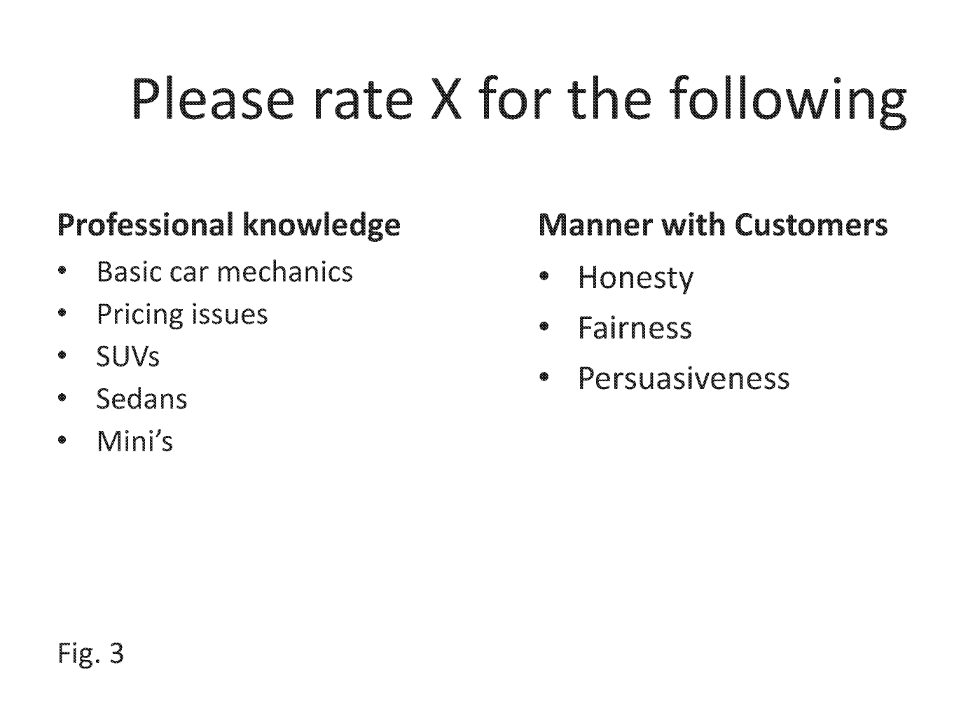

Reference is now made to FIG. 3, which is a simplified diagram showing a screen for rating a car salesperson according to the attributes of professional knowledge and manner with customers. Professional knowledge is broken down into basic car mechanics, pricing issues and different families of cars, in this case SUV's, Sedans and minis. The manner with customers attribute is divided into honesty, fairness and persuasiveness.

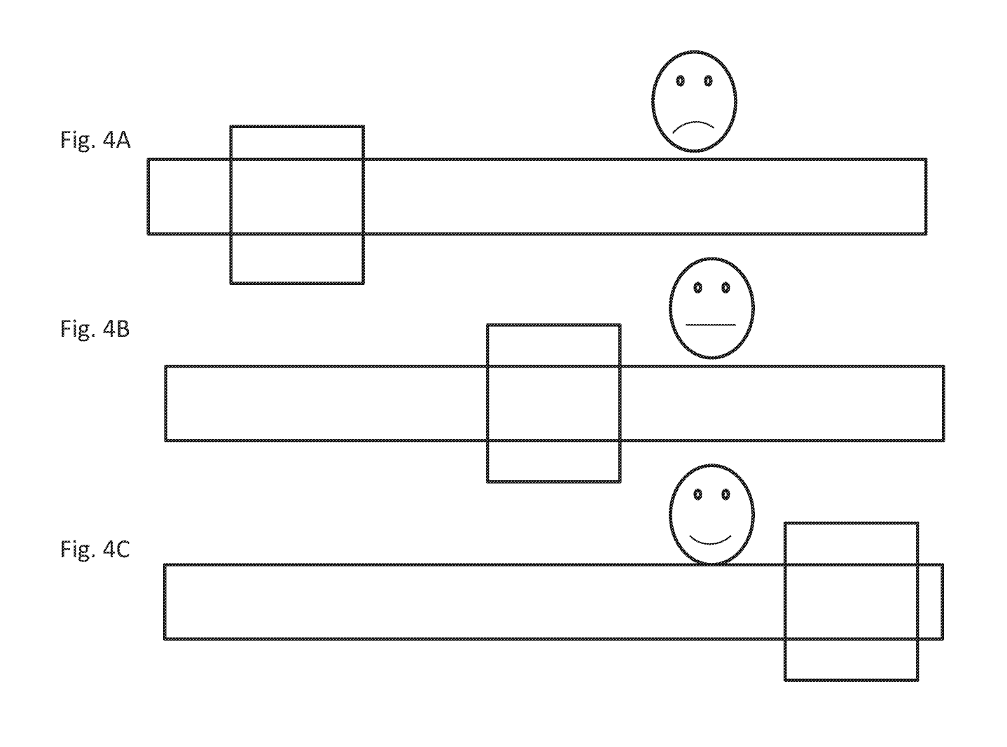

Reference is now made to FIGS. 4A to 4c. Each figure shows a slider for assessing a particular attribute, which slider is set at a different position between a minimum and a maximum setting. Immediately by each slider is an emoticon with an expression which changes as the slider moves between negative and positive values. Furthermore, commentators may be able to comment by directly selecting from a bank of emoticons. Furthermore, individual users may provide themselves with an avatar and the avatar may be able to change color or expression or add accessories in order to express rankings or general feeling behind the ranking.

Rankings or comments may be set as a default of completely private between the person providing the ranking and the person being ranked.

Alternatively, in some circumstances, say in the case of a business wanting rankings from satisfied customers, the results may be exposed to all of the public or to a limited and defined public.

The results may be generally made public, or just limited parts of the results may be made public, as desired.

The apparatus may be financed, say by keyword based advertising. The attributes used and the responses may be used as a source of keywords for targeted advertising.

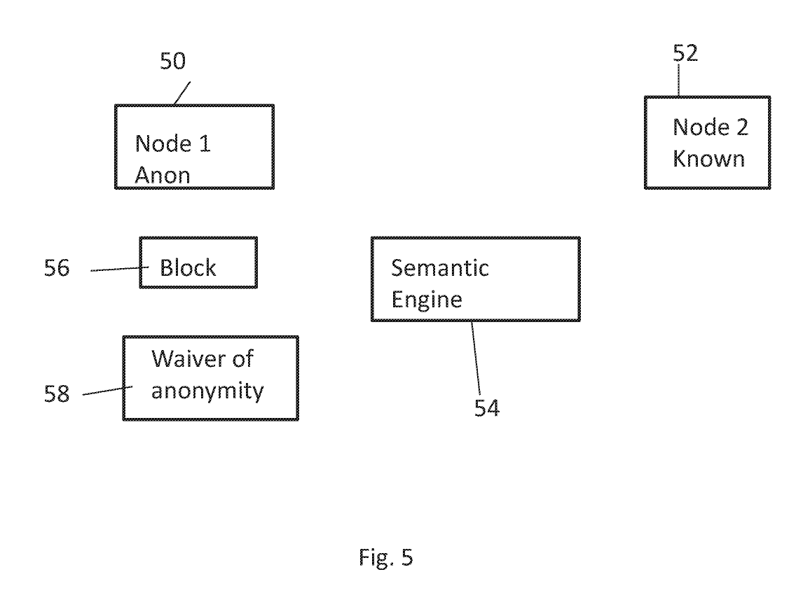

Reference is now made to FIG. 5 which illustrates in greater detail the chat feature 24 of FIG. 1. A user at a first node 50 wishes to communicate anonymously with a known user at a second node 52. The user at node 50 may select the user at the second node from a list and open an anonymous chat session. The user at second node 52 is not provided with the identity of the node 1 user. A semantic engine 54 monitors the chat for misuse, say by looking for words indicating bullying and the like and if found may either pass the details to a human operator or may block the user at the first node 50 using block feature 56. Blocking may be for the individual at node 2 or may be general for the chat system. Likewise the user at node 1 can personally block the user at node 2 using the block feature 56.

The user at node 1 is able to waive anonymity by operating control 58 so as to reveal his/her identity to the user at node 52.

The chat system of FIG. 5 may be used by itself or as part of the rating system of FIG. 1.

It is expected that during the life of a patent maturing from this application many relevant networks and kinds of social media will be developed and the scope of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. System for anonymous user chat between a first anonymous user at a first network node and a second known user at a second node of an electronic network, the system comprising:
a first network node having a first user;
a second network node having a second user;
a list of users at said first node, said list including said second user;
a chat control to allow said first user to select said second user from said list and initiate chat with said second user, said chat initiation being anonymous and thereby not identifying said first node or said first user.

2. The system of claim 1, further comprising a file exchange for allowing files to be exchanged between said nodes.

3. The system of claim 1, further comprising a semantic engine to monitor chat on said network.

4. The system of claim 3, wherein said semantic engine is configured to recognize terms in use between particular sets of chat users.

5. The system of claim 3, wherein said semantic engine is configured to learn terms in use between particular sets of chat users.

6. The system of claim 3, wherein said semantic engine is configured to monitor said chat users for signs of misuse.

7. The system of claim 6, wherein said semantic engine is connected to a blocking unit to block chat users found to have carried out misuse.

8. The system of claim 3, wherein said semantic engine is located on a user device.

9. The system of claim 3, wherein said semantic engine is located on a server.

10. The system of claim 1, further comprising a blocking unit to allow individual chat users to block any other chat user from communicating with them.

11. The system of claim 1, further comprising an anonymity lifting setting to allow a chat user to waive anonymity.

12. The system of claim 1, configured to allow one user to provide one or more other users to comment anonymously on.

13. Method for anonymous user chat between a first anonymous user at a first network node and a second known user at a second node of an electronic network, the method comprising:
allowing a first user to select a second user and initiate chat with said second user, said chat initiation being anonymous and thereby not identifying said first node or said first user.

14. The method of claim 13, further comprising allowing files to be exchanged between said nodes.

15. The method of claim 13, further comprising semantically monitoring chat on said network.

16. The method of claim 15, wherein said monitoring comprises recognizing terms in use between particular sets of chat users.

17. The method of claim 15, comprising semantically learning terms in use between particular sets of chat users.

18. The method of claim 15, comprising semantically monitoring said chat users for signs of misuse.

19. The method of claim 18, comprising blocking chat users found to have carried out misuse.

20. The method of claim 13, further comprising allowing individual chat users to block any other chat user from communicating with them.

21. The method of claim 13, further comprising allowing a chat user to waive anonymity.
